(19) United States
(12) Patent Application Publication
(10) Pub. No.: US 2007/0087164 A1
(43) Pub. Date: Apr. 19, 2007

(54) Three-dimensional decorative article and method for making the same

(76) Inventor: Kirk Joseph Witecha, Delray Beach, FL (US)

Correspondence Address: LOWE HAUPTMAN BERNER, LLP, 1700 DIAGONAL ROAD, SUITE 300, ALEXANDRIA, VA, 22314, US

(21) Appl. No.: 11/248,217

(22) Filed: Oct. 13, 2005

(51) Int. Cl. B32B 3/02; B32B 3/10

(52) U.S. Cl. 428/137; 428/64.1

(57) ABSTRACT

A three-dimensional decorative plastic article includes a thin sheet of synthetic printing material having complementary images printed on each side thereof. The articles also include a pair of superimposed arcuate plastic domes with a thin sheet sandwiched between the domes. A method for making three-dimensional plastic articles includes the steps of printing images on each side of a thin plastic sheet and forming symmetrical arcuate shaped domes on each side of the sheet.

### BACKGROUND OF THE INVENTION

1. Field of the Invention

This invention relates to a three-dimensional decorative article, methods for making such articles and more particularly to three-dimensional plastic articles with a predetermined configuration and a symmetrical cross section.

2. Background for the Invention

Transfer graphic articles with rounded and sealed edges and methods for making such articles are known. For example a U.S. Pat. No. 4,759,982 of Jensen et al. discloses a process for preparing a transfer article having a protective clear coat in precise registration with the graphic. The edges of underlying adhesive are sealed by a clear coat so that solvent resistance is achieved.

A more recent patent of Barthelman U.S. Pat. No. 5,622,587 discloses a method for producing a three-dimensional Laminated Decal Composite. The resulting composite has a predetermined configuration with top edges being curved or arcuate. As disclosed, the method includes providing a decal support for supporting a decal, and securing a decal to the decal support to produce a laminated decal composite. A thermal dye is produced with a dye base and at least one cutting ridge secured to the dye base. The cutting ridge in vertical cross section is essentially shaped as an isosceles triangle with a preferred height of about 0.09 inches. The laminated decal composite is die-cut with a cutting edge of the thermal dye having a cutting temperature, a cutting pressure and a cutting dwell time to produce a three-dimensional laminated decal composite having a predetermined configuration. A three-dimensional laminated decal composite produced in accordance with a method is also disclosed.

Molded articles of laminated/encapsulated substrates are also known. For example a Patent Application Publication of Julius U.S. 2004/0258889 discloses a process for applying an image to a permeable substrate and embedding the substrate in a resin. As disclosed by Julius, a digital image is applied to any of an infinite variety of substrates and sub sequentially embedded in a resin which is translucent/transparent and protective. Optionally, an image may be reproduced by a digital ink jet printer and applied to a substrate. The substrate may then be laminated, incorporated or bonded to a solid surface between layers of resin.

Not withstanding the above, it is presently believed that there may be a commercial market for a novel three-dimensional decorative article with a predetermined configuration and a symmetrical cross section and for methods to make such articles. There should be a demand for such articles because of a pleasing appearance, durability and availability with soft or hard surfaces. Further, such articles may be made in relatively ridged, firm or slightly flexible forms with complementary image profiles on both sides and forming a three-dimensional article. Further, the articles made by the process disclosed herein are applicable as key chains, toys, inexpensive jewelry, or other small articles in various shapes and sizes with various images.

### SUMMARY OF THE INVENTION

In essence, the present invention contemplates a three-dimensional decorative plastic article including a thin sheet of flexible material having complementary image profiles on each side thereof. The articles also include a pair of superimposed arcuate domes with the flat sheet sandwiched between the domes. In one embodiment of the invention, the decorative articles include a passageway through both domes and the substrate and a key ring or other attachment means passes through the passageway.

The invention also contemplates a method for making a three-dimensional decorative article in accordance with the present invention including the steps of providing a thin flat sheet of flexible material such as a synthetic printing sheet. Complementary image profiles are printed on each side of the sheet and the printed sheet is placed on a low-tack paper. The printed sheet is die or precision cut around or along the image profile using care to avoid cutting the low-tack paper; and material outside of the image profile is removed to provide a relatively sharp edge surrounding the image. The low-tack paper is then fixed to a substrate as for example by means of a plurality of vacuum holes. In addition, a mass of liquid plastic such as a clear or transparent urethane resin is provided. The plastic resin is then added i.e. poured onto a first surface of the precision cut printed sheet until the resin is confined by an edge around the image profile due to surface tension to thereby form a first dome shaped cover. The dome on the first side of the printed sheet is then polymerized as for example dried in air at room temperature for a given time to thereby form a semi-finished article. The semi-finished article is then turned over and attached to a first or a second sheet of low-tack paper in the identical location with respect to one another as on the first piece of low-tack paper and liquid plastic is poured onto the second image surface until contained at the edge due to surface tension thus forming a second plastic dome. The second dome is polymerized as for example by air drying for about one day at room temperature or by the addition of hardener or dried at an elevated temperature to form a finished article. The article may have a passageway or hole drilled therethrough for a small ring or other attachment means. It is also contemplated that the article if used for a necklace will merely have a thin chain passing through the passageway.

The invention will now be described in connection with the following drawings.

### DESCRIPTION OF THE DRAWINGS

FIG. 1 is a side elevational view of a three-dimensional decorative article in accordance with a first embodiment of the invention;

FIG. 2 is an exploded perspective view of a three-dimensional decorative article shown in FIG. 1; and

FIG. 3 is block diagram illustrating a method according to a second embodiment of the invention.

### DESCRIPTION OF THE PREFERRED EMBODIMENTS OF THE INVENTION

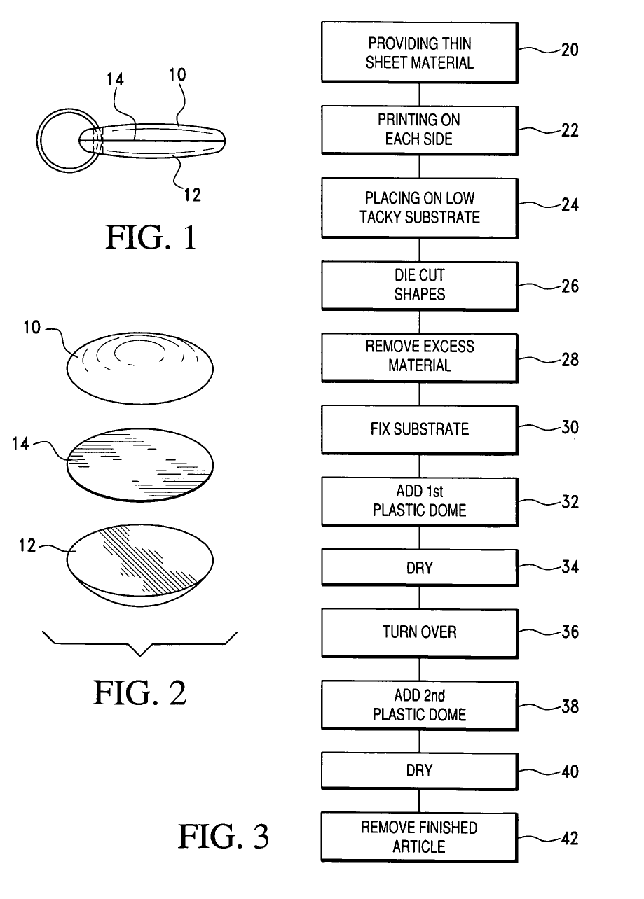

A three-dimensional decorative article 2 in accordance with the present invention is shown in FIGS. 1 and 2. As shown, a flexible thin flat micro porous synthetic printing sheet 14 has a graphic representation or image printed on each side thereof. The printing is done by conventional means as for example by an ink jet or other printer with image profiles aligned with one another as for example, with the two images being superimposed with one upon the other and the image profiles in exact register with one another. The images may for example be of a bottle with an advertising label, a coin or images of each side of the coin or a small animal such as a frog which could show two sides, front or back sides or the front and the back of the animal with one on a side. However the image profiles should be essentially identical.

It is also important that the micro porous synthetic printing sheet 14 is impermeable and prevents water or other fluid from penetrating into the sheet 14 from an outer edge thereof. In a preferred embodiment of the invention, the sheet 14 is TESLIN® sheet from PPG Industries, Inc. of Pittsburgh Pa.

The decorative article 2 also includes a pair of arcuate plastic domes 10 and 12 on each side of the sheet 14. The domes 10 and 12 are preferable made of a clear lensing resin. For example the domes 10 and 12 may be made from CHEM DEC 892 or 892F from CHEMIQUE, Inc. of Indianapolis, Ind. The resins are high quality, two component polyurethane resin systems that can be cured at room or elevated temperatures.

As illustrated in FIG. 1, the two plastic domes 10 and 12 and sheet 14 have a passageway 15 extending through the decorative article 2 and a mounting member such as a key ring 17 attached to the article 2 by passing through the passageway 15.

A method for making decorative articles in accordance with the present invention will now be described in connection with FIG. 3. As shown therein, the first step 20 is to provide a thin flexible synthetic micro porous printing sheet such as a TESLIN® sheet. This TESLIN® sheet is then printed on both sides in step 22 using care to make certain that the image profiles are in register with one another. The printing may be done with any conventional printer. In step 24 the printed sheet is placed on a sheet of low-tack paper. Low-tack paper is available from Avery Dennison manufacturers of label paper or from 3M of St. Paul, Minn. or other manufactures of low-tack paper. Image profiles are precision cut with a ProTech cutter or die cut in step 26 using care that the cutter completely cuts through the micro porous synthetic printing sheet without cutting into the low-tack sheet.

The excess material i.e. the portion of the printed sheet outside of the image profile are removed in step 28 and the low-tack paper is placed on a fixed substrate in step 30 and held in place thereon as for example by vacuum holes after positioning under an automatic mix-dispenser.

The clear lensing resin such as a 3 isocyanatomethyl-3,5,5-trimethylicyclohexyl isocyanate or other suitable plastic is dispensed onto each of the upper surfaces of the images to form a first plastic dome. The resin is added in a controlled amount and flows the edge of the image i.e. the edge formed in step 26. In forming elongated shapes such as a beverage bottle, the resin may be added at 2, 3, or more locations and allowed to flow together and outwardly to the edge until confined by the edge due to surface tension.

The first plastic dome is allowed to dry in step 34 as for example at room temperature for 8-24 hours to form a semi-finished article. Then, after drying the semi-finished articles are turned over in step 36 using care to position the semi-finished articles with respect to the plastic dispensers and with one another in the same location as previously placed. While the semi-finished articles can be turned over onto the same sheet of low-tack paper, it maybe more efficient to turn the low-tack paper with the semi-finished articles thereon and attach the semi-finished articles to a second sheet of low-tack paper and removing the first sheet leaving the semi-finished with the flat surface on an upper side thereof for receiving a second dome. The first low tack sheet may be removed by means of a thin roller to press down on the upper side and lifting up the first tack sheet behind the roller.

After turning the semi-finished article over in step 36, the clear lensing resin is dispensed onto the flat upper surface in step 38 in the same manner as in step 32. Also as in step 32, the low-tack paper is fixed to a substrate under a plurality of plastic dispensers. The second plastic domes are then dried or polymerized in step 40 and the finished articles removed from the low-tack paper in step 42.

The surface of the domes may be relatively soft or have a hard surface based on the composition of the dome and/or the amount of hardener as will be well understood by persons of ordinary skill in the art. Further, the domes may be of a compound with plastic memory so that an indentation by a fingernail will return to it's original form over time.

While the invention has been described in connection with the preferred embodiments, it should be recognized that changes and modifications may be made therein without departing from the scope of the appended claims.

What is claimed is:

1. A three-dimensional decorative article comprising a flexible thin micro porous synthetic printing sheet having complementary images printed on each side thereof and a pair of superimposed symmetrical plastic domes with said flat sheet sandwiched between said domes.

2. A three-dimensional decorative article according to claim 1 in which said plastic domes are transparent.

3. A three-dimensional decorative article according to claim 2 in which said plastic domes are flexible.

4. A three-dimensional decorative article according to claim 2 in which said plastic domes have plastic memory and are deformable and return to their original form after being deformed.

5. A three-dimensional decorative article according to claim 2 in which said plastic domes are arcuate.

6. A three-dimensional decorative article according to claim 2 in which said plastic domes have a surface and said article is rigid with a hard surface.

7. A three-dimensional decorative article according to claim 2, which includes means defining a passageway through, said plastic domes and an attachment member passing through said passageways.

8. A three-dimensional decorative article according to claim 2 in which said thin flat sheet is a microporus synthetic printable sheet.

9. A three-dimensional decorative article according to claim 2 in which said thin flat sheet is vinyl plastic.

10. A three-dimensional decorative article according to claim 2 in which each of said domes is confined by an edge of said thin flat sheet.

11. A three-dimensional decorative article according to claim 2 in which said domes are made of a urethane resin.

12. A method for making a three-dimensional decorative article comprising the steps of:
(a) providing a flexible thin flat micro porous synthetic printing sheet;
(b) printing complementary image profiles on each side of said thin flat sheet;
(c) placing the printed sheet on a low-tack medium;
(d) cutting the printed thin flat sheet around the printed image profile and removing material outside the printed image profile to provide an edge surrounding the image profile without cutting into the low-tack medium;
(e) fixing the low-tack medium to a fixed substrate;
(f) providing a liquid plastic and adding the liquid plastic to a first surface of the die cut printed sheet until the plastic flow is limited by the edge around the image due to surface tension;
(g) polymerizing the plastic to form a dome shaped cover on a first side of the printed plastic sheet to thereby form a semi-finished article;
(h) turning the semi-finished article over;
(i) adding liquid plastic to a second surface of a die cut printed sheet until the plastic flow is limited by the edge surrounding the image due to surface tension;
(j) polymerizing the plastic to form a dome shaped cover on a second side of the printed plastic sheet to form a finished article;
(k) removing the finished article form the tacky medium.

13. A method for making a three-dimensional decorative article according to claim 12 in which said thin flat sheet of flexible material is a microporus synthetic printing sheet.

14. A method for making a three-dimensional decorative article in accordance with claim 12 which includes the step of forming a passageway through the finished article and passing an attachment member through the passageway.

15. A method for making a three-dimensional decorative article in accordance with claim 12 in which the plastic domes are made of a clear polyurethane resin.

16. A method for making a three-dimensional decorative article in accordance with claim 12 in which the resin is cured by drying.

17. A method for making a three-dimensional decorative article in accordance with claim 13 in which the attachment member is a key ring.
